(19) United States
(12) Patent Application Publication
(10) Pub. No.: US 2008/0115139 A1
(43) Pub. Date: May 15, 2008

(54) BARRIER-BASED ACCESS TO A SHARED RESOURCE IN A MASSIVELY PARALLEL COMPUTER SYSTEM

(76) Inventors: Todd Alan Inglett, Rochester, MN (US); Andrew Thomas Tauferner, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/553,613

(22) Filed: Oct. 27, 2006

(51) Int. Cl. G06F 9/46

(52) U.S. Cl. 718/102

(57) ABSTRACT

An apparatus, program product and method utilize a barrier-based mechanism for arbitrating access to a shared resource in a massively parallel computer system. In a first processor among a plurality of processors in a massively parallel computer system, the number of times a barrier has been entered by processors in the massively parallel computer system in association with attempting to access the shared resource may be monitored, and the shared resource may be accessed by the first processor once the number of times the barrier has been entered matches a priority value associated with the first processor. As such, on massively parallel computer systems where potentially thousands of processors may attempt to concurrently access the same shared resource, the access by such processors may be coordinated in a logical fashion to reduce the risk of overwhelming the shared resource due to an excessive number of concurrent access attempts to the shared resource.

### FIELD OF THE INVENTION

The invention is generally directed to computers and computer software, and in particular, to the arbitration of access to a shared computer resource in a massively parallel computer system.

### BACKGROUND OF THE INVENTION

Computer technology has continued to advance at a remarkable pace, with each subsequent generation of a computer system increasing in performance, functionality and storage capacity, and often at a reduced cost. A modern computer system typically comprises one or more central processing units (CPU) and supporting hardware necessary to store, retrieve and transfer information, such as communication buses and memory. A modern computer system also typically includes hardware necessary to communicate with the outside world, such as input/output controllers or storage controllers, and devices attached thereto such as keyboards, monitors, tape drives, disk drives, communication lines coupled to a network, etc.

From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Sophisticated software at multiple levels directs a computer to perform massive numbers of these simple operations, enabling the computer to perform complex tasks. What is perceived by the user as a new or improved capability of a computer system is made possible by performing essentially the same set of very simple operations, but doing it much faster, and thereby enabling the use of software having enhanced function. Therefore continuing improvements to computer systems require that these systems be made ever faster.

The overall speed of a computer system (also called the throughput) may be crudely measured as the number of operations performed per unit of time. Conceptually, the simplest of all possible improvements to system speed is to increase the clock speeds of the various components, and particularly the clock speed of the processor(s). E.g., if everything runs twice as fast but otherwise works in exactly the same manner, the system will perform a given task in half the time. Enormous improvements in clock speed have been made possible by reduction in component size and integrated circuitry, to the point where an entire processor, and in some cases multiple processors along with auxiliary structures such as cache memories, can be implemented on a single integrated circuit chip. Despite these improvements in speed, the demand for ever faster computer systems has continued, a demand which can not be met solely by further reduction in component size and consequent increases in clock speed. Attention has therefore been directed to other approaches for further improvements in throughput of the computer system.

Without changing the clock speed, it is possible to improve system throughput by using a parallel computer system incorporating multiple processors that operate in parallel with one another. The modest cost of individual processors packaged on integrated circuit chips has made this approach practical. Although the use of multiple processors creates additional complexity by introducing numerous architectural issues involving data coherency, conflicts for scarce resources, and so forth, it does provide the extra processing power needed to increase system throughput, given that individual processors can perform different tasks concurrently with one another.

Various types of multi-processor systems exist, but one such type of system is a massively parallel nodal system for computationally intensive applications. Such a system typically contains a large number of processing nodes, each node having its own processor or processors and local (nodal) memory, where the nodes are arranged in a regular matrix or lattice structure. The system contains a mechanism for communicating data among different nodes, a control mechanism for controlling the operation of the nodes, and an I/O mechanism for loading data into the nodes from one or more I/O devices and receiving output from the nodes to the I/O device(s). In general, each node acts as an independent computer system in that the addressable memory used by the processor is contained entirely within the processor's local node, and the processor has no capability to directly reference data addresses in other nodes. However, the control mechanism and I/O mechanism are shared by all the nodes.

A massively parallel nodal system such as described above is a general-purpose computer system in the sense that it is capable of executing general-purpose applications, but it is designed for optimum efficiency when executing computationally intensive applications, i.e., applications in which the proportion of computational processing relative to I/O processing is high. In such an application environment, each processing node can independently perform its own computationally intensive processing with minimal interference from the other nodes. In order to support computationally intensive processing applications which are processed by multiple nodes in cooperation, some form of inter-nodal data communication matrix is provided. This data communication matrix supports selective data communication paths in a manner likely to be useful for processing large processing applications in parallel, without providing a direct connection between any two arbitrary nodes. Optimally, I/O workload is relatively small, because the limited I/O resources would otherwise become a bottleneck to performance.

An exemplary massively parallel nodal system is the IBM Blue Gene®/L (BG/L) system. The BG/L system contains many (e.g., in the thousands) processing nodes, each having multiple processors and a common local (nodal) memory, and with five specialized networks interconnecting the nodes for different purposes. The processing nodes are arranged in a logical three-dimensional torus network having point-to-point data communication links between each node and its immediate neighbors in the network. Additionally, each node can be configured to operate either as a single node or multiple virtual nodes (one for each processor within the node), thus providing a fourth dimension of the logical network. A large processing application typically creates one or more blocks of nodes, herein referred to as communicator sets, for performing specific sub-tasks during execution. The application may have an arbitrary number of such communicator sets, which may be created or dissolved at multiple points during application execution. The nodes of a communicator set typically comprise a rectangular parallelopiped of the three-dimensional torus network.

The hardware architecture supported by the BG/L system and other massively parallel computer systems provides a tremendous amount of potential computing power, e.g., petaflop or higher performance. Furthermore, the architectures of such systems are typically scalable for future increases in performance.

One issue that may arise in massively parallel computer systems, however, relates to contention between nodes or processors attempting to access certain types of shared resources. As an example, the nodes in a massively parallel computer system may all need to access certain external shared resources such as external filesystem, and in certain circumstances, access attempts by multiple nodes or processors can overwhelm an external shared resource, resulting in retries or failures.

One particular instance where such contention can occur is during a boot process for a massively parallel computer system when each processor, or at least a large number of processors, in the system is required to mount an external filesystem as part of its initialization or boot up procedure. In a typical boot process, each processor will typically perform its operations in parallel with other processors. Since in most instances the processors execute the same operating system, the processors often perform the same boot up procedure, which can potentially result in each processor attempting to perform many of the same operations at roughly the same point in time. From the perspective of an external filesystem, however, this can result in the filesystem receiving access attempts from hundreds or thousands of processors at approximately the same point in time. Massively parallel computer systems are by design optimized to handle applications in which the proportion of computational processing relative to I/O processing is high, and consequently, the I/O networks and external resources such as filesystems are typically not designed to handle the high volumes of access attempts that may need to be handled during a boot process. Particularly with respect to mounting operations, which individually have a relatively high overhead, external filesystems can easily become overburdened by an excessive number of processor access attempts received at roughly the same point in time.

Therefore, a significant need exists in the art for an improved manner of arbitrating access to a shared resource in a massively parallel computer system.

### SUMMARY OF THE INVENTION

The invention addresses these and other problems associated with the prior art in providing a barrier-based mechanism for arbitrating access to a shared resource in a massively parallel computer system. Consistent with one aspect of the invention, in a first processor among a plurality of processors in a massively parallel computer system, the number of times a barrier has been entered by processors in the massively parallel computer system in association with attempting to access the shared resource may be monitored, and the shared resource may be accessed by the first processor once the number of times the barrier has been entered matches a priority value associated with the first processor. As such, on massively parallel computer systems where potentially thousands of processors may attempt to concurrently access the same shared resource, the access by such processors may be coordinated in a logical fashion to reduce the risk of overwhelming the shared resource due to an excessive number of concurrent access attempts to the shared resource.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of an exemplary computing environment for providing barrier-based access to a shared resource consistent with the invention.

FIG. 2 is a flowchart illustrating an exemplary barrier-based resource access routine suitable for being executed on a node resident in the computing environment of FIG. 1.

FIGS. 3A-3L are flowcharts illustrating the sequence of operations occurring in a plurality of nodes from the computing environment of FIG. 1 when attempting to access the shared resource.

FIG. 4 is a high level block diagram of a massively parallel computer system suitable for incorporating barrier-based access to a resource consistent with the invention.

FIG. 5 is a simplified representation of a three dimensional lattice structure and inter-nodal communication network in the massively parallel computer system of FIG. 4.

FIG. 6 is a high-level diagram of a compute node in the massively parallel computer system of FIG. 4.

### DETAILED DESCRIPTION

The embodiments described hereinafter utilize a barrier-based technique for arbitrating access to a shared resource by processors in a massively parallel computer system, i.e., typically a computer system including hundreds, if not thousands, of processors or nodes.

A barrier, within the context of the invention, is a software and/or hardware entity that is used to synchronize the operation of processors running executable code. For the purposes of the invention, a barrier typically is considered to support at the concepts of “entering” and “leaving”, whereby a given processor, once entering a barrier, is not permitted to leave the barrier until all other processors with which the processor is being synchronized have also entered the barrier. A barrier is typically global from the standpoint of being common to all of the processors or nodes participating in a common operation or process.

In the illustrated embodiment, for example, a barrier is implemented at least in part using a global interrupt network coupled between each processor. The global interrupt network may be implemented, for example, as a high speed/low latency tree network that enables any processor or node to transmit a request to a common node when reaching a sync point. The request is received by all other processors or nodes, enabling all such processors/nodes to locally determine when all other processors/nodes have reached the same sync point. It will be appreciated, however, that a barrier may be implemented in a number of alternate manners consistent with the invention, e.g., using dedicated software, dedicated hardware, a combination of hardware and software, dedicated wires, message-based interrupts, etc. Embodiments consistent with the invention utilize a barrier to arbitrate access to a shared resource by requiring each processor to monitor the number of times that barrier has been entered by processors in the massively parallel computer system in association with attempting to access the shared resource. Each processor is furthermore assigned a priority value, such that, while monitoring the number of times the common barrier has been entered by processors, the processor is allowed to access the shared resource once the number of times the barrier has been entered matches the priority value associated with that processor. Thus, the processors, whether individually or in groups, essentially take turns accessing a shared resource, thus enabling the load of a shared resource to be maintained at a level that can be accommodated by the shared resource, or even any network to which the shared resource is coupled.

As an example, consider n processors, P₀ through Pₙ₋₁, all wanting to mount a common filesystem, /fs. In one embodiment consistent with the invention, each processor is assigned a unique priority value of x (e.g., x=0 to n−1). All processors are required to enter a common barrier before mounting /fs and count the number of global interrupts. For each processor Pₓ, that processor waits to mount /fs until the number of global interrupts equals x. When the mount of /fs is complete on processor Pₓ, processor Pₓ raises the global interrupt which signals processor Pₓ₊₁ to proceed. In addition, once processor Pₓ has raised the global interrupt, it may proceed with other tasks, or alternatively, may be required to continue to enter the barrier until all other processors have completed the same task.

In another embodiment of the invention, which is discussed in greater detail below, each processor is required to execute a loop that iteratively enters the barrier. Each processor maintains a count of the number of times all of the processors have entered the barrier, and whenever the count matches the priority value assigned to a particular processor, that processor proceeds with accessing the shared resource. The other processors simply wait for that processor to complete the access to the shared resource, whereupon all processors then leave the barrier and iterate through another iteration of the loop. Processors continue to iterate through the loop even after accessing the shared resource, such that no processor proceeds with other tasks until all processors have accessed the shared resource. Put another way, for each processor, access to the shared resource is effectively inhibited until the number of times the barrier has been entered matches the priority value associated with that processor.

A processor may be assigned a priority value in a number of manners consistent with the invention. For example, on a BG/L system, each node or processor is assigned a unique rank. As an alternative, a node or processor may be assigned a value based upon a unique characteristic associated with that processor, e.g., based upon a network address, coordinates in a lattice, a serial number, etc. In addition, processors may be assigned to, or partitioned into, processor groups, with each processor in the group sharing a common priority value such that multiple processors may be permitted to concurrently access the shared resource, which may have the benefit of accelerating the access of a shared resource when the resource will not be overburdened by subsets of processors concurrently accessing the resource. In some embodiments, in the absence of a unique characteristic, each node may also randomly choose a processor group using some random generation technique that provides even and complete distribution among the groups.

The description herein refers to processors as the entities that access a shared resource, and for which access to a shared resource is arbitrated. It will be appreciated that in some embodiments, a processor may be synonymous with a node, while in others, a node may be considered to include multiple processors. In still other embodiments, a physical processor may include multiple logical processors or processor cores, which each may require access to a shared resource. As such, the term “processor” may be used herein for convenience to refer to any entity desiring access to a shared resource, be it a node, physical processor, logical processor, processor core, controller, module, rack, system, etc.

In the illustrated embodiment discussed in greater detail below, where processors or groups of processors take turns accessing a shared resource such as an external file system, a number of benefits are realized. For example, processors or groups of processors will access the external filesystem paced as fast as the network and file servers allow, and typically without requiring any additional network traffic to synchronize access. In addition, each processor or group of processors locally knows its own rank or ordering and waits to access the filesystem until the processor or group of processors before it has taken its turn.

Furthermore, in many embodiments, the arbitration of access to a shared resource may be implemented without requiring processors to communicate with the shared resource to arbitrate the access; often each processor need only be aware of the activities of the other processors, and not necessarily the activities of the shared resource. In environments where the communication overhead associated with accessing a shared resource is relatively high in comparison to the processing bandwidth and inter-processor communication overhead for each processor, avoiding a need to communicate with the shared resource as a component of arbitrating access can provide a substantial performance benefit. Other advantages will be apparent to one of ordinary skill in the art having the benefit of the instant disclosure.

The aforementioned barrier-based technique may be used to arbitrate access to an innumerable number of shared resources. For example, in the illustrated embodiment, barrier-based resource access may be used to control access to an external filesystem used by a massively parallel computer system, and in particular, to minimize the risk of overwhelming an external filesystem during a boot process due to the concurrent receipt of an excessive number of access attempts, e.g., attempts to mount the filesystem. It will be appreciated however, that the techniques described herein may be used to arbitrate access to other types of shared resources where excessive numbers of concurrent access attempts could potentially overwhelm the shared resource, e.g., networks, network components, storage devices, servers, etc.

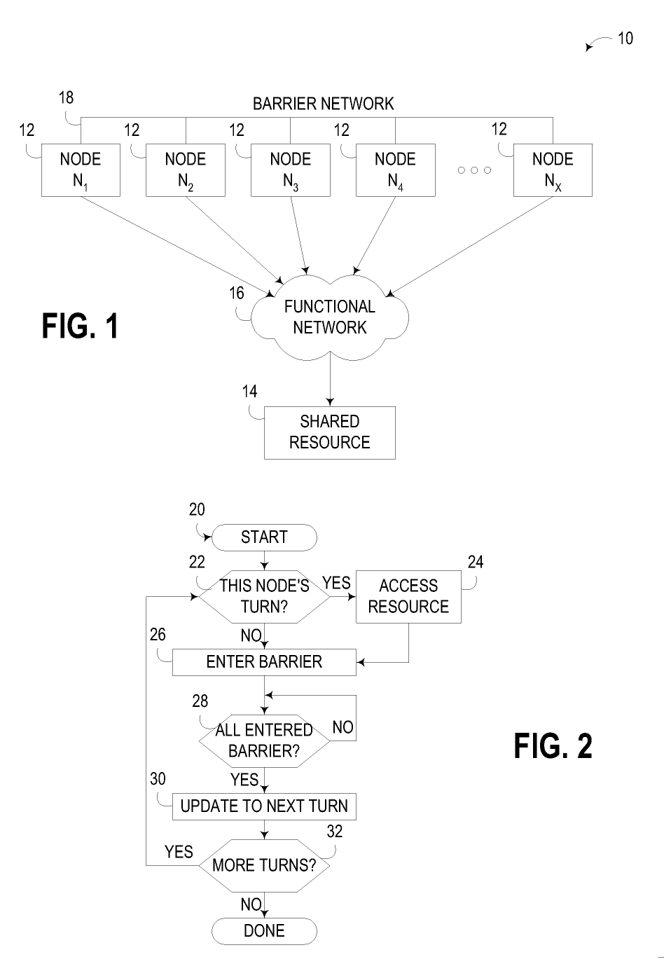

Turning now to the Drawings, wherein like numbers denote like parts throughout the several views, FIG. 1 illustrates an exemplary massively parallel computer system 10 incorporating barrier-based shared resource access consistent with the invention. In this embodiment, processors or other potential requesters of a shared resource are generalized as nodes. As such, FIG. 1 illustrates a system 10 that includes a plurality (1 to x) of nodes 12 attempting to access a shared resource 14 via a functional network 16. In this embodiment, the barrier is implemented using a separate barrier network 18, e.g., a global interrupt network, although in other embodiments a barrier may be implemented over a functional network or another mechanism that enables individual nodes to ascertain when other nodes have entered and left a common barrier.

Each node 12 is configured to execute a barrier-based resource access routine, such as routine 20 of FIG. 2. Routine 20 is called when it is desired to access a shared resource in a synchronized manner with respect to other nodes in system 10. Routine 20 essentially implements a loop that iterates once for each unique priority value assigned to the nodes in system 10. For example, where each node requires exclusive access to the shared resource, the number of iterations of the loop will typically equal the number of nodes. On the other hand, if nodes are grouped together, with multiple nodes sharing the same priority value, the number of iterations will be less than the number of nodes.

Routine 20 begins in block 22 by first determining whether the node is permitted to access the shared resource on the current iteration of the loop, i.e., whether it is this node's “turn” to access the shared resource. In the illustrated embodiment, priority values are assigned from a sequential list of integers, e.g., 0 to x−1 or 1 to x, where x is the total number of nodes or unique groups of nodes. As such, each node is able to track when its “turn” occurs in the loop by comparing the priority value to a similar loop variable. It will be appreciated, however, that in other embodiments, the priority value may be related in other manners to a loop variable or other counter to determine whether a particular iteration of the loop is a particular node's turn. As such, in some instances a priority value may still be considered to match the number of times a barrier has been entered even if the priority value does not equal the number of times the barrier has been entered. For example, any number of mathematical algorithms, tables, etc. may be used to map priority values to the number of times the nodes have entered the barrier.

If a node determines that the node is permitted to access the shared resource, block 22 passes control to block 24 to allow the node to access the shared resource. Once the shared resource has been accessed, control then passes to block 26 to enter the common barrier, e.g., by asserting a global interrupt on a global interrupt network. Returning to block 22, if a node determines that it is not permitted to access the shared resource on this iteration, block 22 passes control directly to block 26 to enter the barrier without allowing the node to access the resource.

Once the node has entered the barrier in block 26, control passes to block 28 to wait until all nodes have entered the barrier. In particular, block 28 loops until all nodes have been determined to have entered the barrier. Various mechanisms may be used to determine when all nodes have entered the barrier. In the illustrated embodiment, for example, a barrier network may be used whereby each node has an output wire extending into a logical AND gate shared by other adjacent nodes. These AND gates feed into a hierarchical structure of AND gates forming a single large logical AND gate of all the nodes. The single AND gate output is routed back to all nodes on a different set of wires. By property of the AND gate the output signal is not asserted until all nodes assert their individual wires.

Other manners of determining when all nodes have entered a barrier may be used. For example, software simulation of the aforementioned barrier entry operation may be implemented, whereby message passing may be used to simulate a network of AND gates by requiring each node to send a message as a “signal” to some mutually agreed-to node that simulates the function of the AND gate by waiting until all nodes send the assertion message. Once messages from all nodes are received at the AND node, the node sends a response to all nodes to permit the nodes to leave the barrier. Further, this simulation technique may be implemented with a hierarchy of nodes acting as AND gates, whereby intermediate level AND gates forward requests to higher level AND gates whenever messages have been received from all lower level nodes coupled to such intermediate nodes.

Once all nodes have entered the barrier, block 28 passes control to block 30 to update to the next turn. Block 30 may be implemented, for example, by incrementing a counter or variable associated with the turn. Block 32 then determines whether more turns remain, i.e., whether any nodes are still awaiting access to the shared resource. If so, control passes to block 22 to proceed through another iteration of the primary loop. Otherwise, all nodes have had the opportunity to access the resource, whereby routine 20 is complete. Block 32 may be implemented, for example, as a comparison against the total number of nodes, or if grouping is permitted, a comparison against the total number of unique priority values.

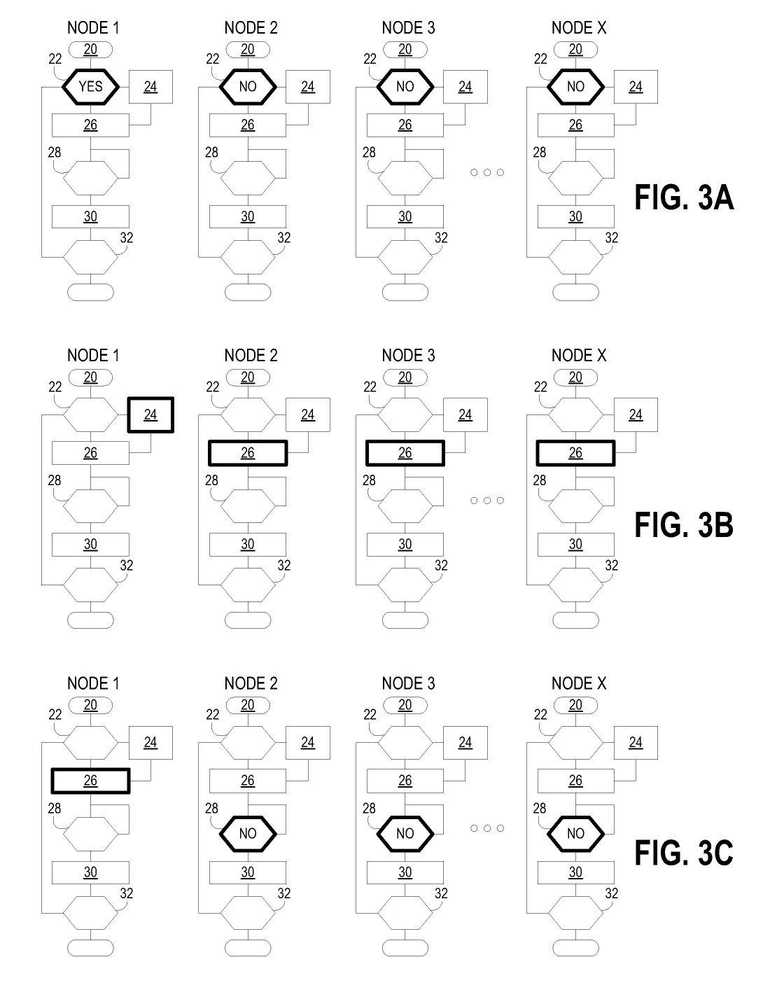

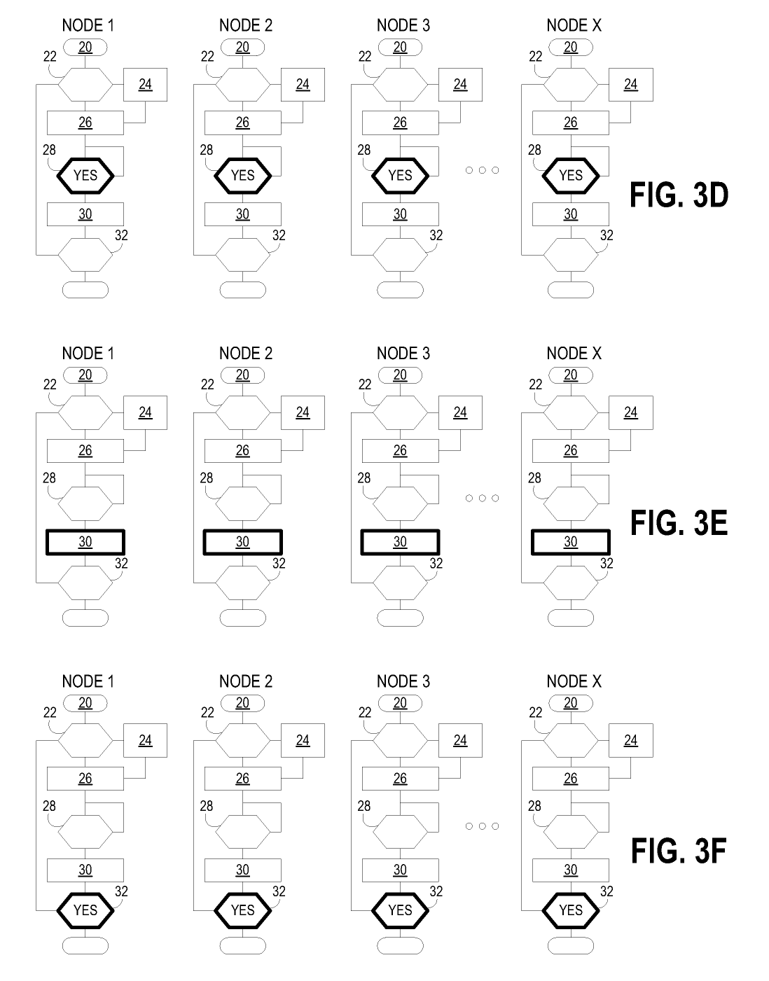

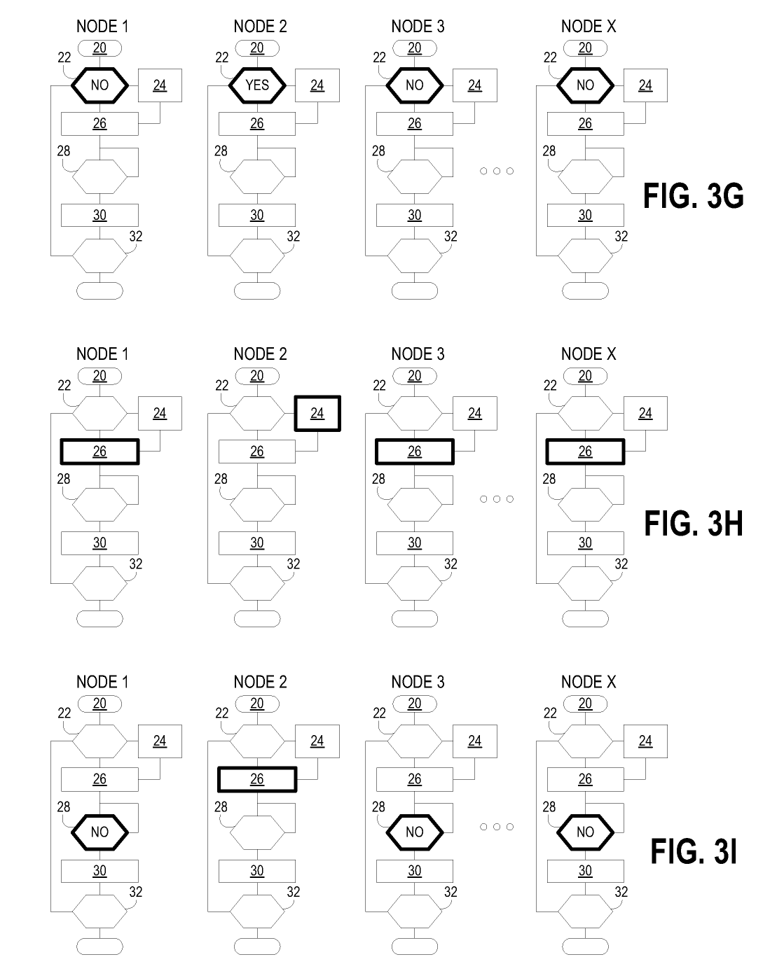

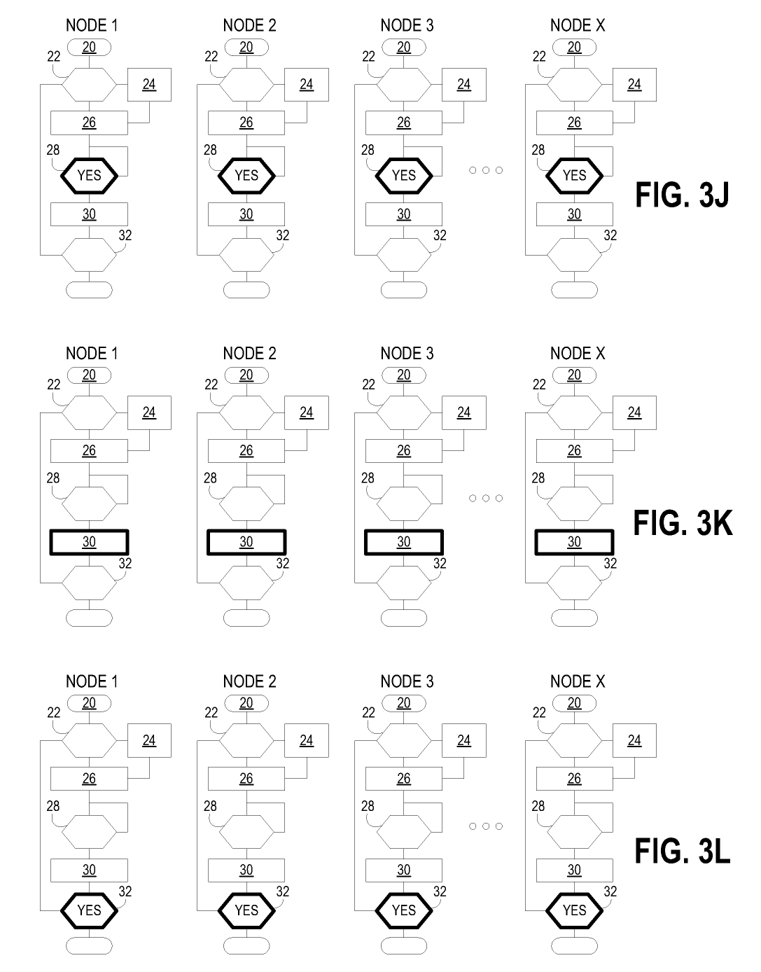

The manner in which routine 20, executing concurrently on a plurality of nodes, can be used to arbitrate access to a shared resource is further illustrated in FIGS. 3A-3L. FIGS. 3A-3F, in particular, illustrate a first iteration through the primary loop of routine 20 in each of a plurality of nodes denoted as nodes 1 to x, when a first node (node 1) is permitted access to the shared resource. FIGS. 3G-3L illustrate a second iteration through the primary loop of the routine in the same plurality of nodes. Each FIG. 3A-3L illustrates the blocks of routine 20 for each node 1 to x, with bolded blocks designating the blocks in routine that are being executed in each figure.

FIG. 3A, for example, illustrates a first step in a first iteration of routine 20, where it is determined by the instance of routine 20 executing on node 1 that it is node 1's turn to access the shared resource (designated by the “yes” indication in block 22). For each of nodes 2 to x, however, a determination is made in each respective instance of routine 20 that it is not the turn of any of nodes 2 to x (designated by the “no” indication in blocks 22).

Next, as shown in FIG. 3B, the instance of routine 20 executing on node 1 passes control to block 24 to access the shared resource. For each other instance of routine 20 on nodes 2 to x, block 24 is bypassed, whereby the respective instance proceeds to enter the barrier in block 26.

Next, as shown in FIG. 3C, once the access to the shared resource is complete, the instance of routine 20 executing on node 1 enters the barrier. At this point, however, each other instance of routine 20 on nodes 2 to x has already determined (as designated by the “no” indication in block 28) that not all nodes have entered the barrier. These instances therefore continue to wait for all nodes to enter the barrier.

Next, as shown in FIG. 3D, node 1 has now completed entering the barrier, and as a result, block 28 executing on all instances of routine 20 determines that all nodes have entered the barrier (designated by the “yes” indication in each block 28). Then, as shown in FIG. 3E, each instance of routine 20 proceeds to block 30 to update to the next turn, e.g., by incrementing a counter. Then, as shown in FIG. 3F, each instance of routine 20 determines that more turns are required (designated by the “yes” indication in each block 32). Control then returns in each instance of routine to block 22 to begin another iteration of the primary loop.

As noted above, FIGS. 3G-3L illustrate a second iteration through the primary loop of the routine in the same plurality of nodes. As shown in FIG. 3G, it is determined by the instance of routine 20 executing on node 2 that it is now node 2's turn to access the shared resource. For each of nodes 1 and 3 to x, however, a determination is made in each respective instance of routine 20 that it is not the turn of any of nodes 1 and 3 to x. Then, as shown in FIG. 3H, the instance of routine 20 executing on node 2 passes control to block 24 to access the shared resource. For each other instance of routine 20 on nodes 1 and 3 to x, block 24 is bypassed, whereby the respective instance proceeds to enter the barrier in block 26.

Next, as shown in FIG. 3I, once the access to the shared resource is complete, the instance of routine 20 executing on node 2 enters the barrier. At this point, however, each other instance of routine 20 on nodes 1 and 3 to x has already determined that not all nodes have entered the barrier. These instances therefore continue to wait for all nodes to enter the barrier. Then, as shown in FIG. 3J, node 2 has now completed entering the barrier, and as a result, block 28 executing on all instances of routine 20 determines that all nodes have entered the barrier. Then, as shown in FIG. 3K, each instance of routine 20 proceeds to block 30 to update to the next turn, e.g., by incrementing a counter. Then, as shown in FIG. 3L, each instance of routine 20 determines that more turns are required (designated by the “yes” indication in each block 32). Control then returns in each instance of routine to block 22 to begin another iteration of the primary loop.

It will be appreciated that the general flow illustrated by FIGS. 3A-3L will continue until every node has had the opportunity to access the shared resource. At that point, block 32 in each instance of routine 20 will determine that no more turns are required, and each instance of the routine will be complete. It will also be appreciated that each node consequently iterates the same number of times through the loop, until all nodes have had the opportunity to access the resource. In other embodiments, however, a node may be permitted to terminate its loop and proceed onto other tasks once that node has accessed the resource.

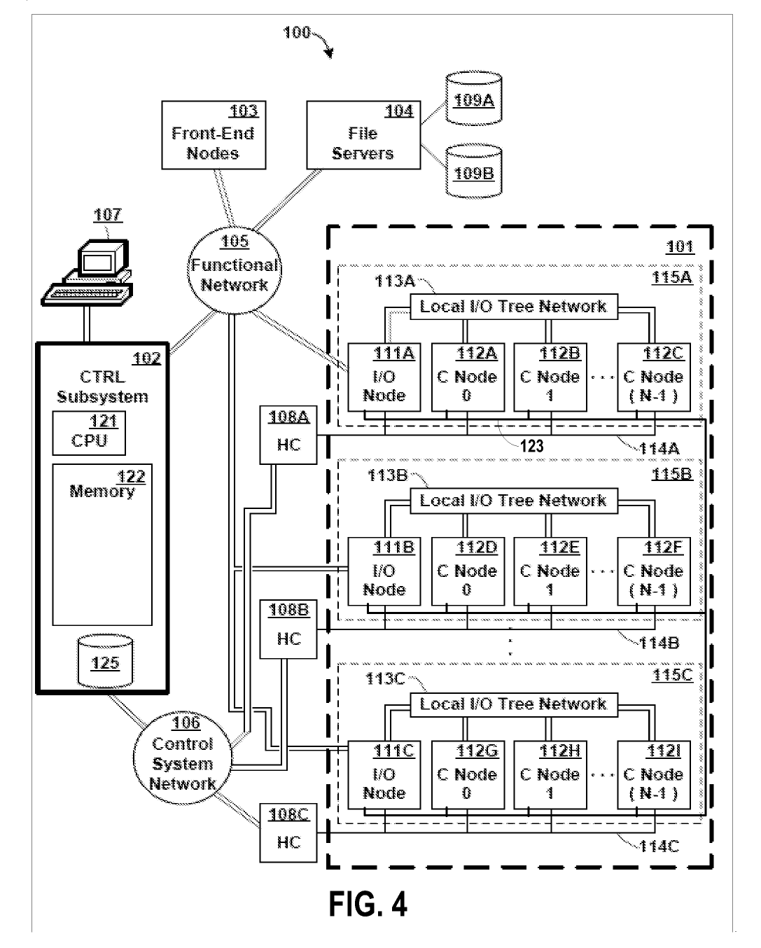

While the techniques described herein may be utilized in a wide variety of computing environments, FIGS. 4-6 illustrate one suitable computing environment within which barrier-based access to a shared resource may be implemented. FIG. 4, in particular, is a high-level block diagram of the major hardware components of an illustrative embodiment of a massively parallel computer system 100 consistent with the invention. In the illustrated embodiment, computer system 100 is an IBM Blue Gene®/L (BG/L) computer system, it being understood that other computer systems could be used, and the description of an illustrated embodiment herein is not intended to limit the present invention to the particular architecture described.

Computer system 100 includes a compute core 101 having a large number of compute nodes arranged in a regular array or matrix, which collectively perform the bulk of the useful work performed by system 100. The operation of computer system 100 including compute core 101 is generally controlled by control subsystem 102. Various additional processors included in front-end nodes 103 perform certain auxiliary data processing functions, and file servers 104 provide an interface to data storage devices such as rotating magnetic disk drives 109A, 109B or other I/O (not shown). Functional network 105 provides the primary data communications path among the compute core 101 and other system components. For example, data stored in storage devices attached to file servers 104 is loaded and stored to other system components through functional network 105. In this embodiment, for example, a file server 104 may be considered a shared resource to which access is requested within the context of barrier-based shared resource access consistent with the invention.

Compute core 101 includes I/O nodes 111A-C (herein generically referred to as feature 111) and compute nodes 112A-I (herein generically referred to as feature 112). Compute nodes 112 are the workhorse of the massively parallel system 100, and are intended for executing compute-intensive applications which may require a large number of processes proceeding in parallel. I/O nodes 111 handle I/O operations on behalf of the compute nodes.

Each I/O node includes an I/O processor and I/O interface hardware for handling I/O operations for a respective set of N compute nodes 112, the I/O node and its respective set of N compute nodes being referred to as a Pset. Compute core 101 includes M Psets 115A-C (herein generically referred to as feature 115), each including a single I/O node 111 and N compute nodes 112, for a total of M×N compute nodes 112. The product M×N can be very large. For example, in one implementation M=1024 (1K) and N=64, for a total of 64K compute nodes.

In general, application programming code and other data input required by the compute core for executing user application processes, as well as data output produced by the compute core as a result of executing user application processes, is communicated externally of the compute core over functional network 105. The compute nodes within a Pset 115 communicate with the corresponding I/O node over a corresponding local I/O tree network 113A-C (herein generically referred to as feature 113). The I/O nodes in turn are attached to functional network 105, over which they communicate with I/O devices attached to file servers 104, or with other system components. Thus, the local I/O tree networks 113 may be viewed logically as extensions of functional network 105, and like functional network 105 are used for data I/O, although they are physically separated from functional network 105.

Control subsystem 102 directs the operation of the compute nodes 112 in compute core 101. Control subsystem 102 may be implemented, for example, as mini-computer system including its own processor or processors 121 (of which one is shown in FIG. 1), internal memory 122, and local storage 125, and having an attached console 107 for interfacing with a system administrator. Control subsystem 102 includes an internal database which maintains certain state information for the compute nodes in core 101, and a control application executing on the control subsystem's processor(s) which controls the allocation of hardware in compute core 101, directs the pre-loading of data to the compute nodes, and performs certain diagnostic and maintenance functions. Control system 102 communicates control and state information with the nodes of compute core 101 over control system network 106. Network 106 is coupled to a set of hardware controllers 108A-C (herein generically referred to as feature 108). Each hardware controller communicates with the nodes of a respective Pset 115 over a corresponding local hardware control network 114A-C (herein generically referred to as feature 114). The hardware controllers 108 and local hardware control networks 114 may be considered logically as extensions of control system network 106, although they are physically separate. The control system network and local hardware control network typically operate at a lower data rate than the functional network 105.

Compute core 101 also includes a barrier network 123, implemented as a global interrupt network, and coupled to each node 111, 112. Barrier network 123 is implemented using a hierarchical tree of logical AND gates coupled to dedicated wires output by each node 111, 112. The overall network forms a single logical AND gate of all of the nodes, with the output of the single AND gate output begin routed back to all nodes on a different set of wires. By property of the AND gate the output signal is not asserted until all nodes assert their individual wires.

In addition to control subsystem 102, front-end nodes 103 each include a collection of processors and memory that perform certain auxiliary functions which, for reasons of efficiency or otherwise, are best performed outside the compute core. Functions that involve substantial I/O operations are generally performed in the front-end nodes. For example, interactive data input, application code editing, or other user interface functions are generally handled by front-end nodes 103, as is application code compilation. Front-end nodes 103 are coupled to functional network 105 for communication with file servers 104, and may include or be coupled to interactive workstations (not shown).

Compute nodes 112 are logically arranged in a three-dimensional lattice, each compute node having a respective x, y and z coordinate. FIG. 2 is a simplified representation of the three dimensional lattice structure 201. Referring to FIG. 2, a simplified 4×4×4 lattice is shown, in which the interior nodes of the lattice are omitted for clarity of illustration. Although a 4×4×4 lattice (having 64 nodes) is represented in the simplified illustration of FIG. 2, it will be understood that the actual number of compute nodes in the lattice is typically much larger. Each compute node in lattice 201 includes a set of six node-to-node communication links 202A-F (herein referred to generically as feature 202) for communicating data with its six immediate neighbors in the x, y and z coordinate dimensions.

As used herein, the term “lattice” includes any regular pattern of nodes and inter-nodal data communications paths in more than one dimension, such that each node has a respective defined set of neighbors, and such that, for any given node, it is possible to algorithmically determine the set of neighbors of the given node from the known lattice structure and the location of the given node in the lattice. A “neighbor” of a given node is any node which is linked to the given node by a direct inter-nodal data communications path, i.e. a path which does not have to traverse another node. A “lattice” may be three-dimensional, as shown in FIG. 2, or may have more or fewer dimensions. The lattice structure is a logical one, based on inter-nodal communications paths. Obviously, in the physical world, it is impossible to create physical structures having more than three dimensions, but inter-nodal communications paths can be created in an arbitrary number of dimensions. It is not necessarily true that a given node's neighbors are physically the closest nodes to the given node, although it is generally desirable to arrange the nodes in such a manner, insofar as possible, as to provide physical proximity of neighbors.

In the illustrated embodiment, the node lattice logically wraps to form a torus in all three coordinate directions, and thus has no boundary nodes. E.g., if the node lattice contains dimx nodes in the x-coordinate dimension ranging from 0 to (dimx−1), then the neighbors of Node((dimx−1), y0, z0) include Node((dimx−2), y0, z0) and Node (0, y0, z0), and similarly for the y-coordinate and z-coordinate dimensions. This is represented in FIG. 2 by links 202D, 202E, 202F which wrap around from a last node in an x, y and z dimension, respectively to a first, so that node 203, although it appears to be at a “corner” of the lattice, has six node-to-node links 202A-F. It will be understood that, although this arrangement is an illustrated embodiment, a logical torus without boundary nodes is not necessarily a requirement of a lattice structure.

The aggregation of node-to-node communication links 202 is referred to herein as the torus network. The torus network permits each compute node to communicate results of data processing tasks to neighboring nodes for further processing in certain applications which successively process data in different nodes. However, it will be observed that the torus network includes only a limited number of links, and data flow is optimally supported when running generally parallel to the x, y or z coordinate dimensions, and when running to successive neighboring nodes. For this reason, applications requiring the use of a large number of nodes may subdivide computation tasks into blocks of logically adjacent nodes (communicator sets) in a manner to support a logical data flow, where the nodes within any block may execute a common application code function or sequence.

FIG. 3 is a high-level block diagram of the major hardware and software components of a compute node 112 of computer system 100 configured in a coprocessor operating mode. It will be appreciated by one of ordinary skill in the art having the benefit of the instant disclosure that each compute node 112 may also be configurable to operate in a different mode, e.g., within a virtual node operating mode.

Compute node 112 includes one or more processor cores 301A, 301B (herein generically referred to as feature 301), two processor cores being present in the illustrated embodiment, it being understood that this number could vary. Compute node 112 further includes a single addressable nodal memory 302 that is used by both processor cores 301; an external control interface 303 that is coupled to the corresponding local hardware control network 114; an external data communications interface 304 that is coupled to the corresponding local I/O tree network 113, and the corresponding six node-to-node links 202 of the torus network; and monitoring and control logic 305 that receives and responds to control commands received through external control interface 303. Monitoring and control logic 305 can access certain registers in processor cores 301 and locations in nodal memory 302 on behalf of control subsystem 102 to read or alter the state of node 112. In the illustrated embodiment, each node 112 is physically implemented as a respective single, discrete integrated circuit chip.

From a hardware standpoint, each processor core 301 is an independent processing entity capable of maintaining state for and executing threads independently. Specifically, each processor core 301 includes its own instruction state register or instruction address register 306A, 306B (herein generically referred to as feature 306) which records a current instruction being executed, instruction sequencing logic, instruction decode logic, arithmetic logic unit or units, data registers, and various other components required for maintaining thread state and executing a thread.

Each compute node can operate in either coprocessor mode or virtual node mode, independently of the operating modes of the other compute nodes. When operating in coprocessor mode, the processor cores of a compute node do not execute independent threads. Processor Core A 301A acts as a primary processor for executing the user application sub-process assigned to its node, and instruction address register 306A will reflect the instruction state of that sub-process, while Processor Core B 301B acts as a secondary processor which handles certain operations (particularly communications related operations) on behalf of the primary processor. When operating in virtual node mode, each processor core executes its own user application sub-process independently and these instruction states are reflected in the two separate instruction address registers 306A, 306B, although these sub-processes may be, and usually are, separate sub-processes of a common user application. Because each node effectively functions as two virtual nodes, the two processor cores of the virtual node constitute a fourth dimension of the logical three-dimensional lattice 201. Put another way, to specify a particular virtual node (a particular processor core and its associated subdivision of local memory), it is necessary to specify an x, y and z coordinate of the node (three dimensions), plus a virtual node (either A or B) within the node (the fourth dimension).

As described, functional network 105 services many I/O nodes, and each I/O node is shared by multiple compute nodes. It should be apparent that the I/O resources of massively parallel system 100 are relatively sparse in comparison with its computing resources. Although it is a general purpose computing machine, it is designed for maximum efficiency in applications which are compute intensive. If system 100 executes many applications requiring large numbers of I/O operations, the I/O resources will become a bottleneck to performance.

In order to minimize I/O operations and inter-nodal communications, the compute nodes are designed to operate with relatively little paging activity from storage. To accomplish this, each compute node includes its own complete copy of an operating system (operating system image) in nodal memory 302, and a copy of the application code being executed by the processor core. Unlike conventional multi-tasking system, only one software user application sub-process is active at any given time. As a result, there is no need for a relatively large virtual memory space (or multiple virtual memory spaces) which is translated to the much smaller physical or real memory of the system's hardware. The physical size of nodal memory therefore limits the address space of the processor core.

As shown in FIG. 3, when executing in coprocessor mode, the entire nodal memory 302 is available to the single software application being executed. The nodal memory contains an operating system image 311, an application code image 312, and user application data structures 313 as required. Some portion of nodal memory 302 may further be allocated as a file cache 314, i.e., a cache of data read from or to be written to an I/O file.

Operating system image 311 contains a complete copy of a simplified-function operating system. Operating system image 311 includes certain state data for maintaining process state. Operating system image 311 is desirably reduced to the minimal number of functions required to support operation of the compute node. Operating system image 311 does not need, and desirably does not include, certain of the functions normally included in a multi-tasking operating system for a general purpose computer system. For example, a typical multi-tasking operating system may include functions to support multi-tasking, different I/O devices, error diagnostics and recovery, etc. Multi-tasking support is typically unnecessary because a compute node supports only a single task at a given time; many I/O functions are not required because they are handled by the I/O nodes 111; many error diagnostic and recovery functions are not required because that is handled by control subsystem 102 or front-end nodes 103, and so forth. In the illustrated embodiment, operating system image 311 includes a simplified version of the Linux operating system, it being understood that other operating systems may be used, and further understood that it is not necessary that all nodes employ the same operating system.

Application code image 312 is desirably a copy of the application code being executed by compute node 112. Application code image 312 may include a complete copy of a computer program that is being executed by system 100, but where the program is very large and complex, it may be subdivided into portions that are executed by different respective compute nodes. Memory 302 further includes a call-return stack 315 for storing the states of procedures that must be returned to, which is shown separate from application code image 312, although it may be considered part of application code state data.

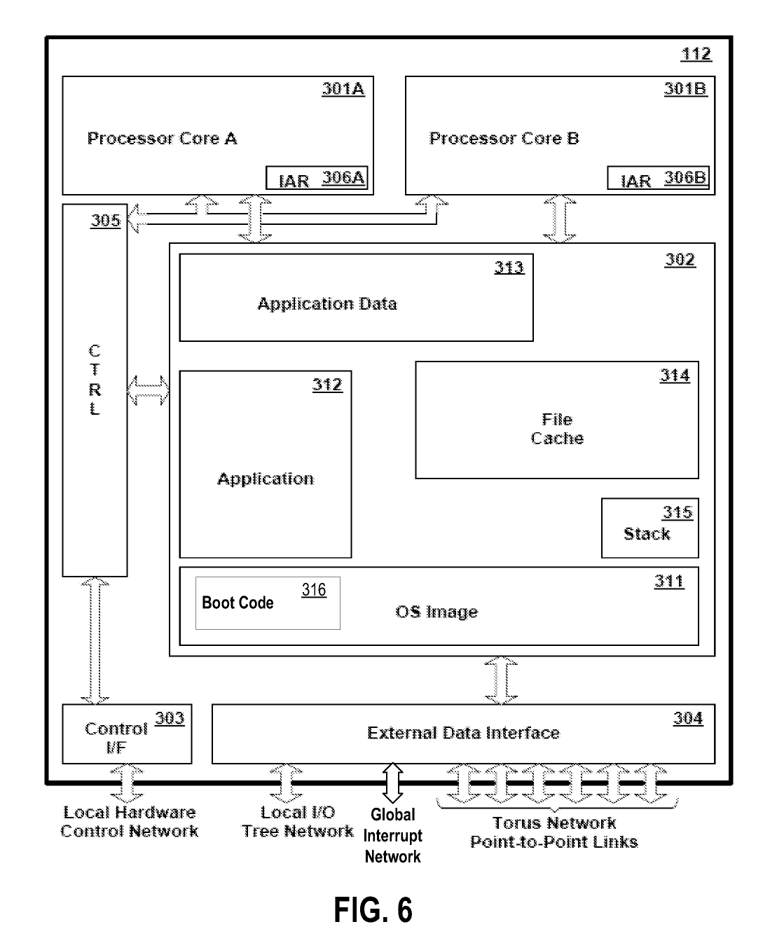

As is also shown in FIG. 6, operating system image 311 includes boot code 316, which is used to boot, or initialize, compute node 112 on start-up or after a system reset. Among other features, it is during this operation that a shared resource such as a filesystem may be accessed, and as such, the aforementioned barrier-based shared resource access technique described herein may be incorporated into boot code 316. For example, it may be desirable to utilize the aforementioned technique to initially mount the filesystem, which due to contention issues arising from potentially thousands of processors or nodes attempting to mount the same filesystem during boot up, could otherwise become overwhelmed and cause an inordinate number of retries or failures.

It will be appreciated that, when executing in a virtual node mode (not shown), nodal memory 302 is subdivided into a respective separate, discrete memory subdivision, each including its own operating system image, application code image, application data structures, and call-return stacks required to support the user application sub-process being executed by the associated processor core. Since each node executes independently, and in virtual node mode, each processor core has its own nodal memory subdivision maintaining an independent state, and the application code images within the same node may be different from one another, not only in state data but in the executable code contained therein. Typically, in a massively parallel system, blocks of compute nodes are assigned to work on different user applications or different portions of a user application, and within a block all the compute nodes might be executing sub-processes which use a common application code instruction sequence. However, it is possible for every compute node 111 in system 100 to be executing the same instruction sequence, or for every compute node to be executing a different respective sequence using a different respective application code image.

In either coprocessor or virtual node operating mode, the entire addressable memory of each processor core 301 is typically included in the local nodal memory 302. Unlike certain computer architectures such as so-called non-uniform memory access (NUMA) systems, there is no global address space among the different compute nodes, and no capability of a processor in one node to address a location in another node. When operating in coprocessor mode, the entire nodal memory 302 is accessible by each processor core 301 in the compute node. When operating in virtual node mode, a single compute node acts as two “virtual” nodes. This means that a processor core 301 may only access memory locations in its own discrete memory subdivision.

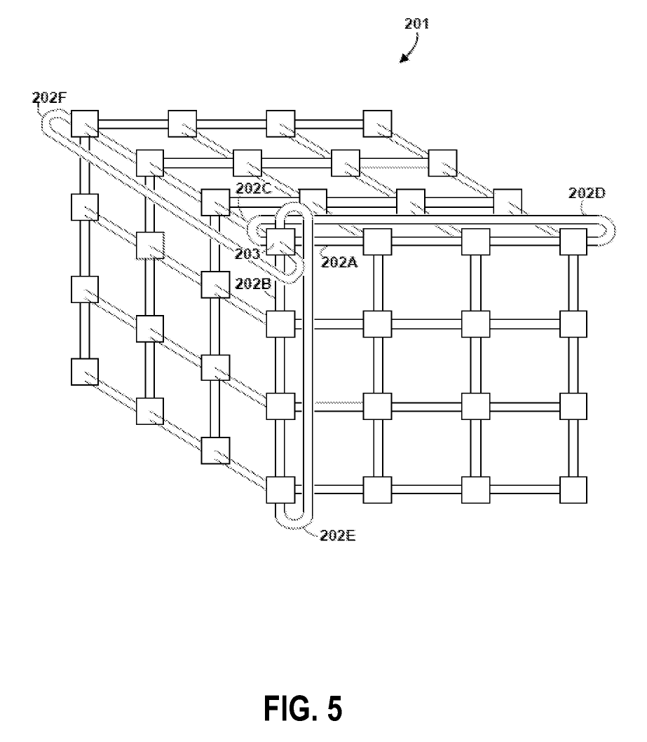

While a system having certain types of nodes and certain inter-nodal communications structures is shown in FIGS. 4 and 5, and a typical node having two processor cores and various other structures is shown in FIG. 6, it should be understood that FIGS. 4-6 are intended only as a simplified example of one possible configuration of a massively parallel system for illustrative purposes, that the number and types of possible devices in such a configuration may vary, and that the system often includes additional devices not shown. In particular, the number of dimensions in a logical matrix or lattice might vary; and a system might be designed having only a single processor for each node, with a number of processors greater than two, and/or without any capability to switch between a coprocessor mode and a virtual node mode. While various system components have been described and shown at a high level, it should be understood that a typical computer system includes many other components not shown, which are not essential to an understanding of the present invention. Furthermore, various software entities are represented conceptually in FIGS. 4 and 6 as blocks or blocks within blocks of local memories 122 or 302. However, it will be understood that this representation is for illustrative purposes only, and that particular modules or data entities could be separate entities, or part of a common module or package of modules, and need not occupy contiguous addresses in local memory. Furthermore, although a certain number and type of software entities are shown in the conceptual representations of FIGS. 4 and 6, it will be understood that the actual number of such entities may vary and in particular, that in a complex computer system environment, the number and complexity of such entities is typically much larger.

The discussion herein has focused on the specific routines utilized to implement the aforementioned functionality. The routines executed to implement the embodiments of the invention, whether implemented as part of an operating system or a specific application, component, program, object, module or sequence of instructions, will also be referred to herein as “computer program code,” or simply “program code.” The computer program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described herein may be identified based upon the application or software component within which it is implemented in a specific embodiment of the invention. However, it should be appreciated that any particular program nomenclature herein is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

Those skilled in the art will recognize that the exemplary environment illustrated in FIGS. 4-6 is not intended to limit the present invention. Indeed, those skilled in the art will recognize that other alternative hardware and/or software environments may be used without departing from the scope of the invention.

Other modifications will be apparent to one of ordinary skill in the art. Therefore, the invention lies in the claims hereinafter appended.

What is claimed is:

1. A method of accessing a shared resource in a massively parallel computer system, the method comprising, in a first processor among a plurality of processors in the massively parallel computer system:
monitoring the number of times a barrier has been entered by processors in the massively parallel computer system in association with attempting to access the shared resource; and
accessing the shared resource once the number of times the barrier has been entered matches a priority value associated with the first processor.

2. The method of claim 1, further comprising, in the first processor, iterating through a loop and entering the barrier during each iteration of the loop, wherein accessing the shared resource is performed only during an iteration of the loop that is associated with the priority value associated with the first processor.

3. The method of claim 2, wherein iterating through the loop includes continuing to iterate through the loop after the first processor has accessed the shared resource.

4. The method of claim 2, wherein iterating through the loop includes terminating the loop after the first processor has accessed the shared resource.

5. The method of claim 2, wherein monitoring the number of times the barrier has been entered includes incrementing a counter during each iteration of the loop, and wherein accessing the shared resource is performed when the number of iterations of the loop matches the priority value associated with the first processor.

6. The method of claim 2, wherein iterating through the loop includes iterating through the loop a number of times equal to the number of unique priority values associated with the plurality of processors.

7. The method of claim 1, wherein each processor among the plurality of processors has a unique priority value.

8. The method of claim 1, wherein the plurality of processors are partitioned into a plurality of processor groups, wherein the processors in each processor group share a common priority value.

9. The method of claim 1, further comprising, in the first processor, locally determining the priority value assigned to the first processor based upon a characteristic of the first processor.

10. The method of claim 1, wherein the first processor is configured to enter the barrier by asserting a global interrupt on a global interrupt facility in the massively parallel computer system.

11. The method of claim 10, wherein the global interrupt facility comprises a global interrupt network coupling the plurality of processors to one another in a tree network.

12. The method of claim 1, wherein the shared resource comprises a filesystem, and wherein accessing the shared resource comprises mounting the filesystem.

13. The method of claim 12, wherein accessing the shared resource is performed during a boot operation in the massively parallel computer system.

14. A method of accessing a shared resource in a massively parallel computer system, the method comprising:
iteratively entering a barrier in each processor among a plurality of processors in the massively parallel computer system; and
inhibiting access to the shared resource by a first processor among the plurality of processors in the massively parallel computer system until the number of times the barrier has been entered matches a priority value associated with the first processor.

15. The method of claim 14, further comprising accessing the shared resource with the first processor once the number of times the barrier has been entered matches the priority value associated with the first processor.

16. The method of claim 15, wherein iteratively entering the barrier includes iterating through a loop, entering the barrier during each iteration of the loop, and incrementing a counter during each iteration of the loop, wherein accessing the shared resource is performed only when the number of iterations of the loop matches the priority value associated with the first processor.

17. An apparatus, comprising:
a first processor configured to be coupled to a plurality of processors in a massively parallel computer system; and
program code executable by the first processor to access a shared resource in the massively parallel computer system by monitoring the number of times a barrier has been entered by processors in the massively parallel computer system in association with attempting to access the shared resource, and accessing the shared resource once the number of times the barrier has been entered matches a priority value associated with the first processor.

18. The apparatus of claim 17, further comprising the plurality of processors and a global interrupt network coupling the plurality of processors to one another, wherein the first processor is configured to enter the barrier by asserting a global interrupt on the global interrupt network.

19. The apparatus of claim 18, wherein each processor among the plurality of processors has a unique priority value.

20. The apparatus of claim 18, wherein the plurality of processors are partitioned into a plurality of processor groups, wherein the processors in each processor group share a common priority value.

21. The apparatus of claim 17, wherein the program code is configured to iterate through a loop and enter the barrier during each iteration of the loop, and wherein the program code is configured to access the shared resource only during an iteration of the loop that is associated with the priority value associated with the first processor.

22. The apparatus of claim 21, wherein the program code is configured to monitor the number of times the barrier has been entered by incrementing a counter during each iteration of the loop, and to access the shared resource only when the number of iterations of the loop matches the priority value associated with the first processor.

23. The apparatus of claim 21, wherein the program code is configured to iterate through the loop by iterating through the loop a number of times equal to the number of unique priority values associated with the plurality of processors.

24. The apparatus of claim 17, wherein the shared resource comprises a filesystem, and wherein the program code is configured to access the shared resource by mounting the filesystem.

25. A program product, comprising:
program code configured to be executed by a first processor among a plurality of processors in a massively parallel computer system to access a shared resource in the multiprocessor computer system by monitoring the number of times a barrier has been entered by processors in the massively parallel computer system in association with attempting to access the shared resource, and accessing the shared resource once the number of times the barrier has been entered matches a priority value associated with the first processor; and
a computer readable medium bearing the program code.
